(19) United States
(12) Patent Application Publication
(10) Pub. No.: US 2026/0321894 A1
(43) Pub. Date: Oct. 15, 2026

(54) ALL-SOLID-STATE BATTERY

(71) Applicant: SAMSUNG SDI CO., LTD., Yongin-si, Gyeonggi-do (KR)

(72) Inventors: Isaac SHIN, Yongin-si, Gyeonggi-do (KR); Yijin KANG, Yongin-si, Gyeonggi-do (KR); Kwang Jong SUH, Yongin-si, Gyeonggi-do (KR); Young Gyoon RYU, Yongin-si, Gyeonggi-do (KR)

(73) Assignee: SAMSUNG SDI CO., LTD., Yongin-si, Gyeonggi-do (KR)

(21) Appl. No.: 18/879,059

(22) PCT Filed: Apr. 16, 2024
(86) PCT No.: PCT/KR2024/005053

§ 371 Date: Dec. 26, 2024

(30) Foreign Application Priority Data
Dec. 15, 2023 (KR) 10-2023-0182534

(51) Int. Cl. H01M 50/477; H01M 10/613; H01M 10/653; H01M 10/6551; H01M 50/105; H01M 50/143; H01M 50/211; H01M 50/474

(52) U.S. Cl. CPC H01M 50/477; H01M 10/613; H01M 10/653; H01M 10/6551; H01M 50/105; H01M 50/143; H01M 50/211; H01M 50/474

(57) ABSTRACT

The present invention relates to an all-solid-state battery, and in more detail, the all-solid-state battery includes a first stack including at least one first battery cell and at least one first elastic pad; a first pouch enclosing the first stack; a first end plate on the first stack; a second end plate under the first stack, the first and second end plates sandwiching the first stack; and a first metal spring pad interposed between the first and second end plates.

### TECHNICAL FIELD

The present invention relates to an all-solid-state battery.

### BACKGROUND ART

Recently, due to industrial demands, the development of batteries with high energy density and safety is being actively conducted. For example, lithium ion batteries are being put to practical use not only in the information-related devices and communication devices fields, but also in the automobile field. In the automobile field, safety is especially important because it is related to life.

All-solid-state batteries may greatly reduce the possibility of fire or explosion even if short circuit occurs by not using a flammable organic dispersion medium. Therefore, the all-solid-state batteries may have excellent safety.

### DISCLOSURE

### Technical Problem

The task that the present invention intends to solve is to provide an all-solid-state battery with a long lifespan.

Another task that the present invention intends to solve is to provide an all-solid-state battery that may be used over a wide temperature range.

### Technical Solution

An all-solid-state battery according to an embodiment of the present invention may include: a first stack including at least one first battery cell and at least one first elastic pad; a first pouch enclosing the first stack; a first end plate on the first stack; a second end plate under the first stack, the first and second end plates sandwiching the first stack; and a first metal spring pad interposed between the first and second end plates.

### Advantageous Effects

The all-solid-state battery according to the present invention may be used at high and low temperatures and may have excellent lifespan characteristics.

### DESCRIPTION OF DRAWINGS

FIG. 1 is a plan view for explaining an all-solid-state battery according to embodiments of the present invention.

FIG. 2 is a cross-sectional view for explaining an all-solid-state battery according to embodiments of the present invention.

FIG. 3 is a cross-sectional view for explaining a battery cell according to embodiments of the present invention.

FIGS. 4A and 4B are perspective views for explaining metal springs according to embodiments of the present invention.

FIGS. 5 to 10 are cross-sectional views illustrating all-solid-state batteries according to embodiments of the present invention.

FIG. 11 is a graph examining the usable temperature of a metal spring pad according to an embodiment of the present invention.

FIGS. 12, 13A, and 13B are graphs examining the lifespan characteristics of a metal spring pad according to an embodiment of the present invention.

### MODE FOR INVENTION

In order to sufficiently understand the configuration and effect of the present invention, preferred embodiments of the present invention will be described with reference to the accompanying drawings. However, the present invention is not limited to the following exemplary embodiments, and may be implemented in various forms. Rather, the exemplary embodiments are provided only to completely disclose the present invention and let those skilled in the art fully know the scope of the present invention.

In this description, when an element is referred to as being on another element, the element can be directly on the other element or intervening elements may be present between therebetween. In the drawings, thicknesses of some components are exaggerated for effectively explaining the technical contents. Like reference numerals refer to like elements throughout the specification.

The embodiments described in the description will be described with reference to cross-sectional, plan and/or perspective views, which are ideal examples of the present invention. Although terms such as first, second, third, or the like have been used in various embodiments in the description to describe various components, these components should not be limited by these terms. These terms are only used to distinguish one component from another. The embodiments described and illustrated herein also include complementary embodiments thereof.

The terminology used herein is for the purpose of describing embodiments and is not intended to limit the invention. In this description, the singular form includes the plural form unless specifically stated otherwise. The terms “comprises” and/or “comprising” as used in the description do not exclude the presence or addition of one or more other components.

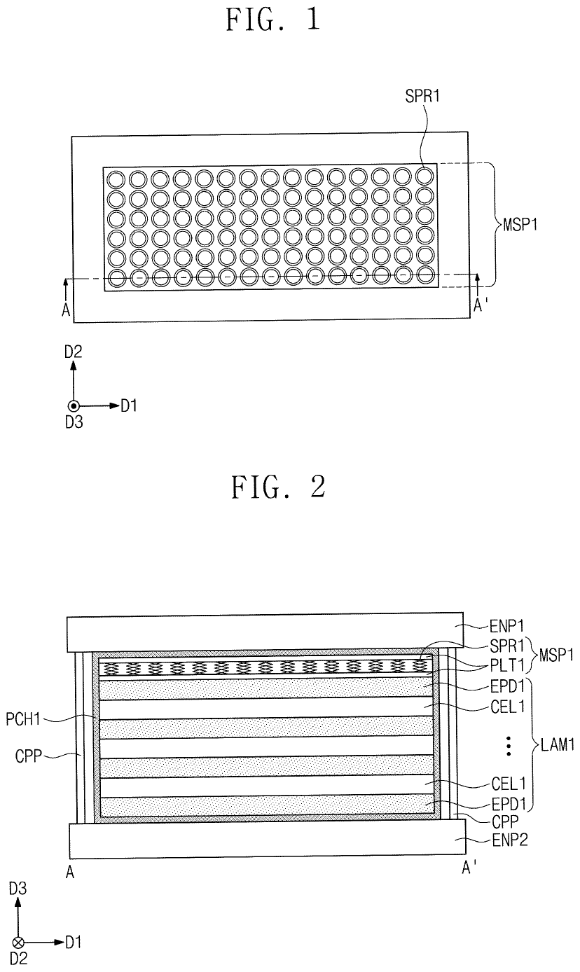

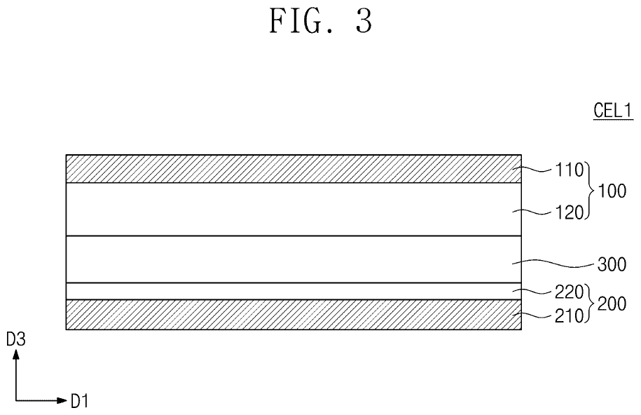

FIG. 1 is a plan view for explaining an all-solid-state battery according to embodiments of the present invention. FIG. 2 is a diagram for explaining an all-solid-state battery according to embodiments of the present invention and is a cross-sectional view cut along line A-A′ in FIG. 1.

Referring to FIGS. 1 and 2, an all-solid-state battery may include a first stack (LAM1), a first pouch (PCH1), a first end plate (ENP1), a second end plate (ENP2), a first metal spring pad (MSP1), and a coupling point (CPP).

The first stack (LAM1) may include at least one first battery cell (CEL1) and at least one first elastic pad (EPD1). The first stack (LAM1) may include a plurality of first battery cells (CEL1) and a plurality of first elastic pads (EPD1). The first stack (LAM1) may be formed by alternately stacking the plurality of first battery cells (CEL1) and the plurality of first elastic pads (EPD1). For example, the first stack (LAM1) may be formed by stacking the first battery cell (CEL1) on the first elastic pad (EPD1) and stacking the first elastic pad (EPD1) on the first battery cell (CEL1). However, the present invention is not limited to the described embodiment.

Each of the first elastic pads (EPD1) may relieve stress generated according to a change in the volume of the first battery cell (CEL1) during charging and discharging. Each of the first elastic pads (EPD1) may be composed of elastically deformable members, and more specifically, may be composed of a material having a lower elasticity than that of a positive electrode current collector and a negative electrode current collector. Each of the first elastic pads (EPD1) may include an insulating material. For example, the material of the first elastic pad (EPD1) may include, but is not limited thereto, an epoxy resin, an acrylic resin, a polyimide resin, a polyester resin, a polypropylene resin, a polyamide resin, a polystyrene resin, a polyvinyl chloride resin, a polycarbonate resin, a fluororesin such as PTFE, and silicone rubber.

The first metal spring pad (MSP1) may be interposed between the first end plate (ENP1) and the second end plate (ENP2). For example, referring to FIG. 2, the first metal spring pad (MSP1) may be positioned between the first stack (LAM1) and the first end plate (ENP1). Alternatively, the first metal spring pad (MSP1) may be positioned between the first stack (LAM1) and the second end plate (ENP2).

The first metal spring pad (MSP1) may include a first metal spring (SPR1) and a first metal plate (PLT1).

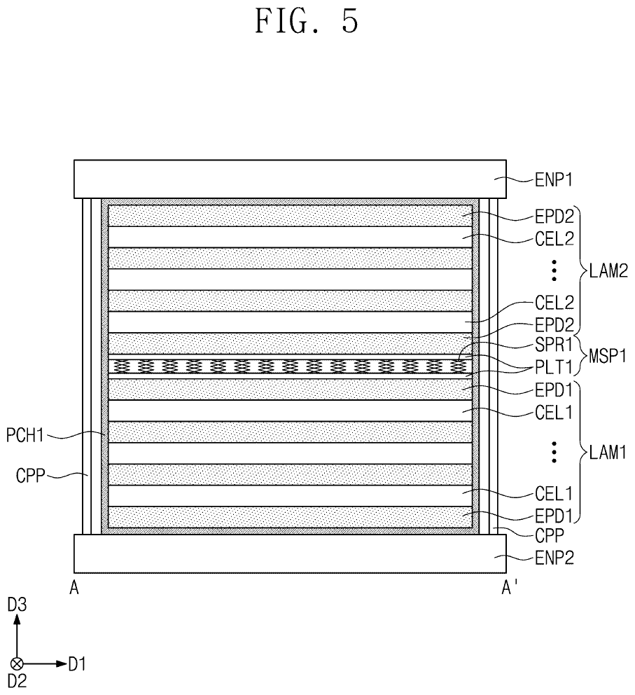

The first metal spring (SPR1) may include a plurality of metal springs that are two-dimensionally arranged on the first metal plate (PLT1). For example, the plurality of metal springs may be arranged at regular intervals along a first direction D1 and a second direction D2 intersecting the first direction D1 (see FIG. 1). That is, the plurality of metal springs may be arranged in a checkerboard pattern. The plurality of metal springs may be arranged closely together. For example, the distance between adjacent metal springs may be about 0 mm to about 3 mm. The first metal spring (SPR1) may be composed of a plurality of metal spring units (SPR1a, see FIG. 4A and FIG. 4B), which will be described in detail in FIG. 4.

The first metal plate (PLT1) may include a plurality of metal plates. The first metal spring (SPR1) may be interposed between the plurality of metal plates. For example, the first metal spring (SPR1) may be interposed between a lower metal plate and an upper metal plate.

The first metal spring pad (MSP1) may provide elasticity. During charging and discharging an all-solid-state battery, the first metal spring pad (MSP1) may minimize the change in pressure inside the first battery cell (CEL1).

The thickness of the first metal spring pad (MSP1) may be about 3 mm to about 30 mm, specifically about 10 mm to about 25 mm. If the thickness of the first metal spring pad (MSP1) is smaller than the range, elasticity may not be provided to allow the first battery cell (CEL1) to sufficiently contract. If the thickness of the first metal spring pad MSP1 is larger than the range, the energy density of the first battery cell (CEL1) may decrease.

The area of the first metal spring pad (MSP1) may be equal to or greater than the area of the first stack (LAM1).

The first metal spring pad (MSP1) may be used at about −50 °C to about 150 °C The first metal spring pad (MSP1) may exhibit its original function without change in elasticity at an appropriate temperature of a battery.

The first metal spring pad (MSP1) may be used even at high temperatures. For example, the first metal spring pad (MSP1) may not be broken even if used at a temperature of about 70 °C or higher.

The first metal spring pad (MSP1) may be used even at low temperatures. For example, the first metal spring pad (MSP1) may not be hardened even if used at temperatures of about 20 °C or less.

The first metal spring pad (MSP1) may be heat-dissipating. For example, the thermal conductivity of the first metal spring pad (MSP1) may be from about 0.01 W/mK to about 30 W/mK.

The first metal spring pad (MSP1) may be non-combustible.

The first pouch (PCH1) may enclose the first stack (LAM1). For example, the first stack (LAM1) may be injected inside the first pouch (PCH1) and sealed in a vacuum state by the first pouch (PCH1). For example, referring to FIG. 2, the first pouch (PCH1) may enclose the first stack (LAM1) and the first metal spring pad (MSP1) together.

The first end plate ENP1 may be positioned on the first stack LAM1. The second end plate ENP2 may be positioned under the first stack LAM1. The first and second end plates (ENP1 and ENP2) may sandwich the first stack (LAM1). The first and second end plates (ENP1 and ENP2) may apply a constant pressure to the first stack (LAM1) and suppress an increase in the internal resistance of the first stack (LAM1).

The first and second end plates (ENP1 and ENP2) may have a first metal spring pad (MSP1) interposed therebetween.

The coupling point (CPP) may be configured to couple the first and second end plates (ENP1 and ENP2) to each other. The first and second end plates (ENP1 and ENP2) may be fixed to each other by the coupling point (CPP).

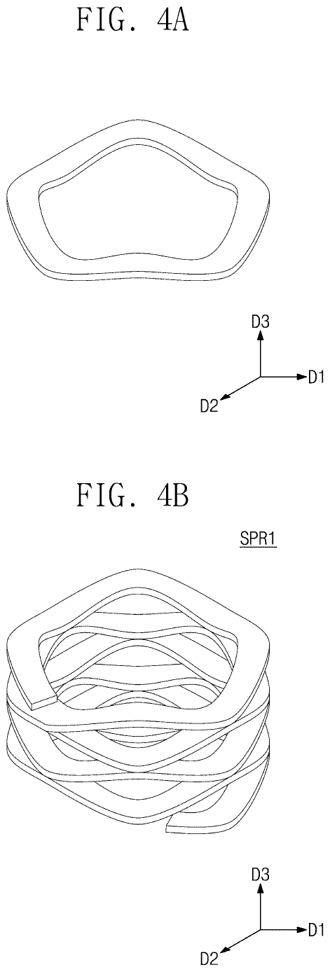

FIG. 3 is a cross-sectional view for explaining a first battery cell (CEL1) according to embodiments of the present invention.

Referring to FIG. 3, each of the first battery cells (CEL1) may include a positive electrode layer (100), a negative electrode layer (200) facing the positive electrode layer (100), and a solid electrolyte layer (300) disposed between the positive electrode layer (100) and the negative electrode layer (200). However, the first battery cell (CEL1) may further include an additional functional layer such as an adhesion enhancing layer, disposed between the positive electrode layer (100) and the solid electrolyte layer (300) or between the negative electrode layer (200) and the solid electrolyte layer (300), without limitation.

The positive electrode layer (100) may include a positive electrode current collector (110) and a positive electrode active material layer (120) disposed on the positive electrode current collector (110). The positive electrode active material layer (120) may include a positive electrode active material, a solid electrolyte, a conductive material, and a binder.

The positive electrode current collector (110) may provide a reference surface on which the positive electrode active material layer (120) is disposed. The positive electrode current collector (110) may have a plate or foil shape. For example, the positive electrode current collector (110) may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Different from FIG. 3, in an embodiment of the present invention, the positive electrode current collector (110) may be omitted. Although not shown, a carbon layer having a thickness of about 0.1 μm to about 4 μm may be additionally disposed between the positive electrode current collector (110) and the positive electrode active material layer (120) to increase the bonding strength between the positive electrode current collector (110) and the positive electrode active material layer (120).

The positive electrode active material may be a material that may reversibly absorb and desorb lithium ions. For example, the positive electrode active material may include, but is not limited thereto, lithium transition metal oxides such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate and lithium iron phosphate, nickel sulfide, copper sulfide, lithium sulfide, iron oxide, or vanadium oxide. The positive electrode active materials may be used solely or may be a mixture of two or more thereof.

The lithium transition metal oxide may be a compound represented by any one among, for example, LiₐA_{1-b}B_{b}D₂ (0.90≤a≤1, 0≤b≤0.5), LiₐE_{1-b}B_{b}O_{2-c}D_{c} (0.90≤a≤1, 0≤b≤0.5, 0≤c≤0.05), LiE_{2-b}B_{b}O_{4-c}D_{c} (0≤b≤0.5, 0≤c≤0.05), LiₐNi_{1-b-c}Co_{b}B_{c}Dₐ (0.90≤a≤1, 0≤b≤0.5, 0≤c≤0.05, 0<α<2), LiₐNi_{1-b-c}Co_{b}B_{c}O_{2-α}F_{α} (0.90≤a≤1, 0≤b≤0.5, 0≤c≤0.05, 0<α<2), LiₐNi_{1-b-c}Mn_{b}B_{c}D_{α} (0.90≤a≤1, 0≤b≤0.5, 0≤c≤0.05, 0<α≤2), LiₐNi_{1-b-c}Mn_{b}B_{c}O_{2-α}F_{α} (0.90≤a≤1, 0≤b≤0.5, 0≤c≤0.05, 0<α<2), LiₐNi_{b}E_{c}GaO₂ (0.90≤a≤1, 0≤b≤0.9, 0≤c≤0.5, 0.001≤d≤0.1), LiₐNi_{b}Co_{c}Mn_{d}GeO₂ (0.90≤a≤1, 0≤b≤0.9, 0≤c≤0.5, 0≤d≤0.5, 0.001≤e≤0.1), LiₐNiG_{b}O₂ (0.9≤a≤1, 0.001≤b≤0.1), LiₐCoG_{b}O₂ (0.90 ≤a≤1, 0.001≤b≤0.1), LiₐMnG_{b}O₂ (0.90≤a≤1, 0.001≤b≤0.1), LiₐMn₂G_{b}O₄ (0.90≤a≤1, 0.001≤b≤0.1), QO₂, QS₂, LiQS₂, V₂O₅, LiV₂O₅, LiIO₂, LiNiVO₄, Li_{3-f}J₂(PO₄)₃ (0≤f≤2), Li_{3-f}Fe₂ (PO₄)₃ (0≤f≤2), and LiFePO₄. In the compounds, the capital letter “A” is Ni, Co, Mn, or a combination thereof, the capital letter “B” is Al, Ni, Co, Mn, Cr, Fe, Mg, Sr, V, a rare earth element, or a combination thereof, the capital letter “D” is O, F, S, P, or a combination thereof, the capital letter “E” is Co, Mn, or a combination thereof, the capital letter “F” is F, S, P, or a combination thereof, the capital letter “G” is Al, Cr, Mn, Fe, Mg, La, Ce, Sr, V, or a combination thereof, the capital letter “Q” is Ti, Mo, Mn, or a combination thereof, the capital letter “I” is Cr, V, Fe, Sc, Y, or a combination thereof, and the capital letter “J” is V, Cr, Mn, Co, Ni, Cu, or a combination thereof.

The positive electrode active material may include, for example, a lithium salt of a transition metal oxide having a layered rock salt type structure among the lithium transition metal oxides described above. The “layered rock salt type structure” is, for example, a structure in which oxygen atomic layers and metal atomic layers are alternately and regularly arranged in the <111> direction of a cubic rock salt type structure, whereby each atomic layer forms a two-dimensional plane. The “cubic rock salt type structure” refers to a sodium chloride (NaCl type) structure, which is a type of crystal structure, and specifically refers to a structure in which face-centered cubic lattices (fcc) formed by each of cations and anions are misaligned by ½ the ridge of a unit lattice. The lithium transition metal oxide having such a layered rock salt type structure may be, for example, a ternary lithium transition metal oxide such as LiNiₓCo_{y}Al_{z}O₂ (NCA) or LiNiₓCo_{y}Mn_{z}O₂ (NCM) (0<x<1, 0<y<1, 0<z<1, x+y+z=1). If the positive electrode active material includes the ternary lithium transition metal oxide having the layered rock salt type structure, the energy density of the first battery cell (CEL1) may increase and the thermal stability may be improved.

The above-described compound included in the positive electrode active material may be covered by a coating layer (not shown). The positive electrode active material may also be a mixture of the above-described compound and a compound to which a coating layer is added. Meanwhile, the coating layer added to the surface of the positive electrode active material may include, for example, an oxide, a hydroxide, an oxyhydroxide, an oxycarbonate, or a hydroxycarbonate of the coating elements below. The compound forming the coating layer may be amorphous or crystalline. The coating elements included in the coating layer may include Mg, Al, Co, K, Na, Ca, Si, Ti, V, Sn, Ge, Ga, B, As, Zr, or a mixture thereof. The coating layer may include, for example, Li₂O—ZrO₂ (LZO). The method of forming the coating layer may be selected within a range that does not adversely affect the physical properties of the positive electrode active material. The method of forming the coating layer may include, for example, a spray coating method or an immersion method.

If the positive electrode active material is a ternary lithium transition metal oxide such as NCA or NCM and contains nickel (Ni), the capacity density of the first battery cell (CEL1) may be increased, thereby reducing metal elution of the positive electrode active material in a charged state. As a result, the cycle characteristics of the first battery cell (CEL1) in a charged state may be improved. Meanwhile, the “cycle characteristics” are characteristics indicating the degree to which the first battery cell (CEL1) is deteriorated due to the charging/discharging of the first battery cell (CEL1). A first battery cell (CEL1) with high cycle characteristics may have a small degree of deterioration of the first battery cell (CEL1) due to charging/discharging, and a first battery cell (CEL1) with low cycle characteristics may have a large degree of deterioration of the first battery cell (CEL1) due to charging/discharging.

The shape of the positive electrode active material may include particle shapes such as spheres and ellipsoids. The particle diameter and content of the positive electrode active material are not particularly limited.

The solid electrolyte may include a sulfide-based solid electrolyte having excellent lithium ion conductivity characteristics. The sulfide-based solid electrolyte may include, for example, at least one selected from the group consisting of Li₂S—P₂S₅, Li₂S—P₂S₅—LiX (X represents a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂-LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and the capital letter “Z” represents any one of Ge, Zn, or Ga), Li₂S—GeS₂, Li₂S—SiS₂—Li₃PO₄, Li₂S—SiS₂—LiₚMO_{q} (p and q are positive numbers, and the capital letter “M” represents any one of P, Si, Ge, B, Al, Ga, or In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2).

The sulfide-based solid electrolyte may be, for example, an argyrodite-type compound including one or more selected from Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound including one or more selected from Li₆PS₅Cl, Li₆PS₅Br and Li₆PS₅I. The density of the argyrodite-type solid electrolyte may be about 1.5 g/cc to about 2.0 g/cc. If the argyrodite-type solid electrolyte has a density of about 1.5 g/cc or more, the internal resistance of an all-solid-state battery may be reduced, and a defect in which a solid electrolyte membrane is penetrated and short-circuited due to the formation of lithium dendrites, may be prevented. The elastic modulus of the solid electrolyte may be, for example, about 15 GPa to about 35 GPa.

The solid electrolyte included in the positive electrode active material layer (120) may have a smaller average particle diameter (D50) than the solid electrolyte included in the solid electrolyte layer (300). For example, the average particle diameter (D50) of the solid electrolyte included in the positive electrode active material layer (120) may be about 90% or less, about 80% or less, about 70% or less, about 60% or less, about 50% or less, about 40% or less, about 30% or less, or about 20% or less of the average particle diameter (D50) of the solid electrolyte included in the solid electrolyte layer (300). Meanwhile, the average particle diameter (D50) may be a median diameter measured using a laser type particle size distribution meter.

The positive electrode active material layer (120) may include a conductive material. The conductive material may have conductivity without causing a chemical change in the first battery cell (CEL1), thereby increasing the conductivity of the positive electrode active material and the solid electrolyte. The conductive material may include a carbon-based material. The conductive material may include, for example, one or more selected from graphite, carbon black, acetylene black, carbon nanofibers, and carbon nanotubes.

The positive electrode active material layer (120) may further include a binder. The binder may include a material for binding the positive electrode active material, the solid electrolyte, and the conductive material included in the positive electrode active material layer (120) and improving the bonding strength with the positive electrode current collector (110). For example, the binder may include polyvinylidene fluoride, styrene butadiene rubber (SBR), polytetrafluoroethylene, polyvinylidene fluoride, vinylidene fluoride/hexafluoropropylene copolymer, polyacrylonitrile, or polymethyl methacrylate.

If the total amount of the positive electrode active material, the solid electrolyte, the conductive material, and the binder is about 100 parts by weight, the positive electrode active material layer (120) may include about 85 parts by weight to about 92 parts by weight of the positive electrode active material. The positive electrode active material layer (120) may include about 0.5 parts by weight to about 1.5 parts by weight of the binder.

In the positive electrode active material layer (120), the conductive material may have about 1 part by weight to about 50 parts by weight relative to about 100 parts by weight of the solid electrolyte. If the conductive material is less than about 1 part by weight relative to about 100 parts by weight of the solid electrolyte, the electrical conductivity of the positive electrode active material layer (120) may be reduced. If the conductive material is more than about 50 parts by weight relative to about 100 parts by weight of the solid electrolyte, the ratio of the conductive material may be excessively high, and a covering layer covering the surface of the solid electrolyte may not be properly formed.

According to embodiments, the positive electrode active material layer (120) may further include at least one additive selected from the group consisting of a filler, a coating agent, a dispersant, and an ion conductive assistant in addition to the above-described positive electrode active material, solid electrolyte, conductive material, and binder.

The solid electrolyte layer (300) is disposed between the positive electrode layer (100) and the negative electrode layer (200) and may include a sulfide-based solid electrolyte having excellent lithium ion conductivity characteristics. The solid electrolyte included in the solid electrolyte layer (300) may be the same as or different from any one of the materials that may be included in the solid electrolyte included in the positive electrode active material layer (120) described above.

The solid electrolyte layer (300) of an embodiment may include a sulfide-based solid electrolyte. The sulfide-based solid electrolyte may be formed by, for example, treating starting materials such as Li₂S and P₂S₅ by a melting rapid cooling method or a mechanical milling method. In addition, a heat treatment may be performed after the treatment. The solid electrolyte may be amorphous, crystalline, or a mixture state thereof. In addition, the solid electrolyte may include, for example, at least sulfur (S), phosphorus (P), and lithium (Li) as constituent elements among the above-described sulfide-based solid electrolyte materials. For example, the solid electrolyte may be a material including Li₂S—P₂S₅. If using Li₂S—P₂S₅ as the sulfide-based solid electrolyte material to form the solid electrolyte, the mixing molar ratio of Li₂S and P₂S₅ is, for example, in the range of Li₂S:P₂S₅=50:50 to 90:10.

The sulfide-based solid electrolyte may be, for example, an argyrodite-type compound including one or more selected from Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound including one or more selected from Li₆PS₅Cl, Li₆PS₅Br and Li₆PS₅I. The density of the argyrodite-type solid electrolyte may be about 1.5 g/cc to about 2.0 g/cc. If the argyrodite-type solid electrolyte has a density of about 1.5 g/cc or more, the internal resistance of the all-solid-state battery may be reduced, and a defect in which a solid electrolyte membrane may be penetrated and short-circuited due to the formation of lithium dendrites, may be prevented. The elastic modulus of the solid electrolyte is, for example, about 15 GPa to about 35 GPa.

The solid electrolyte layer (300) may further include a binder. The binder in the solid electrolyte layer (300) may be, for example, styrene butadiene rubber (SBR), polytetrafluoroethylene, polyvinylidene fluoride, polyethylene, or the like, but is not limited thereto. The binder of the solid electrolyte layer (300) may be the same as or different from the binder included in the positive electrode active material layer (120) or the binder included in the negative electrode coating layer (220).

The negative electrode layer (200) may include a negative electrode current collector (210) and a negative electrode coating layer (220) on the negative electrode current collector (210). The negative electrode current collector (210) may provide a reference surface on which the negative electrode coating layer (220) is disposed. The negative electrode current collector (210) may include, for example, a material that does not react with lithium, i.e., does not form an alloy or a compound with lithium. For example, the negative electrode current collector (210) may include at least one metal selected from the group consisting of copper (Cu), stainless steel, titanium (Ti), iron (Fe), cobalt (Co), and nickel (Ni). The thickness of the negative electrode current collector (210) may be about 1 μm to about 20 μm, more specifically about 5 μm to about 15 μm, more specifically about 7 μm to about 10 μm.

The negative electrode current collector (210) may be composed of one of the above-described metals, or may include an alloy or coating material of two or more metals. The negative electrode current collector (210) may have, for example, a plate shape or a foil shape. Meanwhile, in an embodiment, the negative electrode current collector (210) may be omitted.

The negative electrode coating layer (220) may allow lithium metal to grow between the negative electrode coating layer (220) and the negative electrode current collector (210) during charging. The negative electrode coating layer (220) may act as a protective layer for lithium metal and suppress the precipitation and growth of lithium dendrites.

The negative electrode coating layer (220) may include a metal and carbon. For example, the negative electrode coating layer (220) may include at least one metal selected from the group consisting of gold (Au), platinum (Pt), palladium (Pd), silicon (Si), silver (Ag), aluminum (Al), bismuth (Bi), tin (Sn) and zinc (Zn). The negative electrode coating layer (220) may include at least one carbon selected from the group consisting of carbon black, acetylene black, furnace black, ketjen black, and graphene. In an embodiment, the negative electrode coating layer (220) may include a mixture of carbon black and silver (Ag).

The negative electrode coating layer (220) may further include other additives in addition to metal and carbon. The negative electrode coating layer (220) may further include at least one additive selected from the group consisting of, for example, a binder, a filler, a coating agent, a dispersant, and an ion conductive assistant.

The negative electrode coating layer (220) may be thinner than the positive electrode active material layer (120). The thickness of the negative electrode coating layer (220) may be, for example, about 50% or less, about 40% or less, about 30% or less, about 20% or less, about 10% or less, or about 5% or less of the thickness of the positive electrode active material layer (120). The thickness of the negative electrode coating layer (220) may be, for example, about 1 μm to about 20 μm, about 2 μm to about 10 μm, or about 3 μm to about 7 μm. If the thickness of the negative electrode coating layer (220) is too thin, lithium dendrites formed between the negative electrode coating layer (220) and the negative electrode current collector (210) may collapse the negative electrode coating layer (220), thereby deteriorating the cycle characteristics of the first battery cell (CEL1). If the thickness of the negative electrode coating layer (220) increases excessively, the energy density of the first battery cell (CEL1) may decrease and the internal resistance of the first battery cell (CEL1) due to the negative electrode coating layer (220) may increase, thereby deteriorating the cycle characteristics of the first battery cell (CEL1).

Meanwhile, although not shown, a carbon layer may be further included to improve the bonding strength between the negative electrode coating layer (220) and the solid electrolyte layer (300).

FIG. 4A and FIG. 4B are perspective views for explaining a first metal spring (SPR1) according to embodiments of the present invention. FIG. 4A is a perspective view for explaining a first metal spring unit (SPR1a) constituting a first metal spring (SPR1) according to embodiments of the present invention.

The first metal spring (SPR1) of the first metal spring pad (MSP1) explained in FIG. 1 and FIG. 2 may include a plurality of first metal spring units (SPR1a).

The first metal spring unit (SPR1a) may be a rotating body having a central axis along a third direction (D3). In addition, the first metal spring unit (SPR1a) may have an inner diameter and an outer diameter that is larger than the inner diameter. That is, the first metal spring unit (SPR1a) may have a ring shape in a planar view.

Referring to FIG. 4A, in an embodiment of the present invention, the first metal spring unit (SPR1a) may have a height that varies in the third direction along the circumference. For example, the upper and lower surfaces of the first metal spring unit (SPR1a) may have a height that increases or decreases in the third direction (D3) along the circumference. For example, the first metal spring unit (SPR1a) may have a wave shape in which the height varies in the third direction along the circumference.

The diameter of the first metal spring unit (SPR1a) may be about 5 mm to about 50 mm based on the outer diameter.

Referring to FIG. 4B, the first metal spring (SPR1) may include a plurality of first metal spring units (SPR1a). The first metal spring (SPR1) may have a form in which a plurality of first metal spring units (SPR1a) are stacked in the third direction (D3). The stacked plurality of first metal spring units (SPR1a) may be connected with each other to form one first metal spring (SPR1).

The first metal spring (SPR1) may include a coil spring, a leaf spring, a volute spring, a ring spring, a reel spring, a disc spring, a washer spring, a wave spring, a snap spring, a torsion bar spring, or the like, and is not limited to the described form.

The material of the first metal spring (SPR1) may include at least one selected from the group consisting of stainless steel (steel use stainless; SUS) and hard drawn steel.

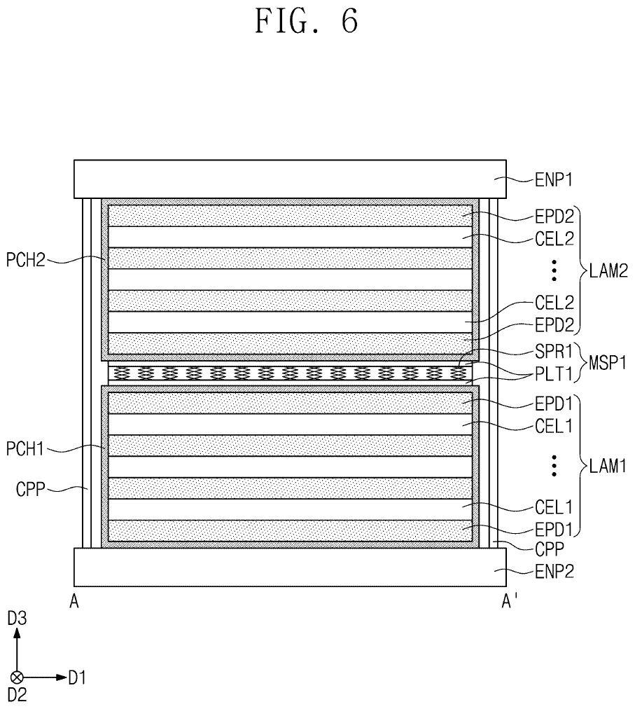

FIGS. 5 to 9 are cross-sectional views showing all-solid-state batteries according to embodiments of the present invention. Hereinafter, for convenience of explanation, descriptions of the same matters as those described with reference to FIG. 2 will be omitted and differences will be described in detail.

Referring to FIG. 5, the all-solid-state battery may further include a second stack (LAM2) on the first stack (LAM1). The first spring pad (MSP1) may be interposed between the first stack (LAM1) and the second stack (LAM2). A first pouch (PCH1) may enclose the first stack (LAM1), the second stack (LAM2), and the first spring pad (MSP1) together.

The second stack (LAM2) may include at least one second battery cell (CEL2) and at least one second elastic pad (EPD2). The second stack (LAM2) may include a plurality of second battery cells (CEL2) and a plurality of second elastic pads (EPD2). The second stack (LAM2) may be formed by alternately stacking the plurality of second battery cells (CEL2) and the plurality of second elastic pads (EPD2). For example, the second stack (LAM2) may be formed by stacking the second battery cell (CEL2) on the second elastic pad (EPD2), and stacking the second elastic pad (EPD2) on the second battery cell (CEL2). However, the present invention is not limited to the described embodiment.

Each of the second battery cells (CEL2) may include a positive electrode layer, a negative electrode layer facing the positive electrode layer, and a solid electrolyte layer disposed between the positive electrode layer and the negative electrode layer. However, the second battery cell (CEL2) may further include an additional functional layer such as an adhesion enhancing layer, disposed between the positive electrode layer and the solid electrolyte layer or between the negative electrode layer and the solid electrolyte layer, without limitation. The specific components of each of the second battery cells (CEL2) may be the same as or different from those of the first battery cells (CEL1).

Each of the second elastic pads (EPD2) may include an insulating material. For example, the material of the second elastic pad (EPD2) may include, but is not limited thereto, an epoxy resin, an acrylic resin, a polyimide resin, a polyester resin, a polypropylene resin, a polyamide resin, a polystyrene resin, a polyvinyl chloride resin, a polycarbonate resin, a fluororesin such as PTFE, a silicone rubber, or the like. The specific composition of each of the second elastic pads (EPD2) may be the same as or different from that of the first elastic pads (EPD1).

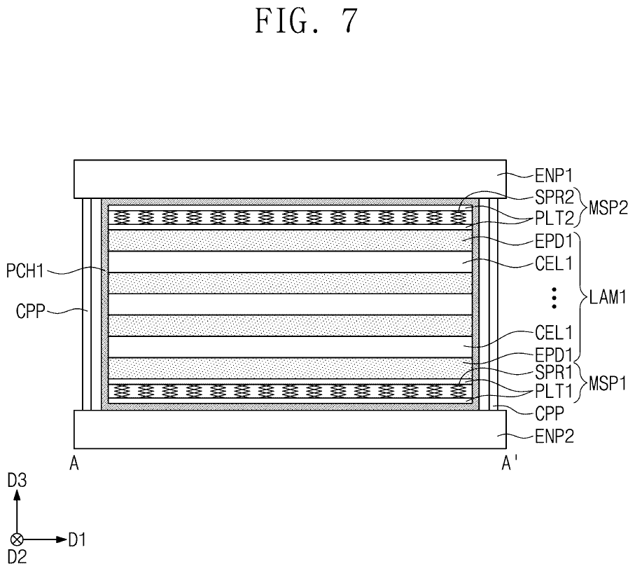

Referring to FIG. 6, the all-solid-state battery may further include a second pouch (PCH2). The first metal spring pad (MSP1) may be interposed between the first pouch (PCH1) and the second pouch (PCH2).

The second pouch (PCH2) may selectively enclose only the second stack (LAM2) excluding the first metal spring pad (MSP1). For example, the second stack (LAM2) may be injected into the second pouch (PCH2) and sealed in a vacuum state.

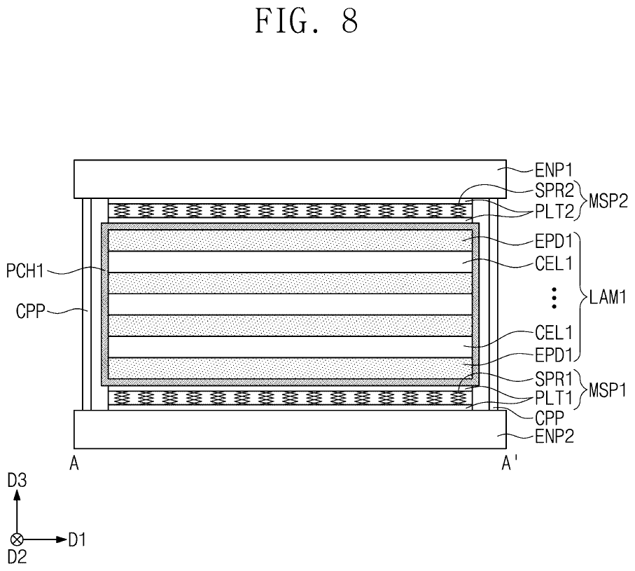

Referring to FIG. 7, the all-solid-state battery may further include a second metal spring pad (MSP2). The second metal spring pad (MSP2) may be positioned on the first stack (LAM1). The second metal spring pad (MSP2) may be spaced apart from the first metal spring pad (MSP1) in a vertical direction (i.e., the third direction (D3)). In other words, the first stack (LAM1) may be positioned between the first metal spring pad (MSP1) and the second metal spring pad (MSP2). For example, the first metal spring pad (MSP1) may be interposed between the first stack (LAM1) and the second end plate (EPD2), and the second metal spring pad (MSP2) may be interposed between the first stack (LAM1) and the first end plate (EPD1). Alternatively, the first metal spring pad (MSP1) may be interposed between the first stack (LAM1) and the first end plate (EPD1), and the second metal spring pad (MSP2) may be interposed between the first stack (LAM1) and the second end plate (EPD2). The first pouch (PCH1) may enclose the first stack (LAM1), the first metal spring pad (MSP1), and the second metal spring pad (MSP2) together.

The second metal spring pad (MSP2) may include a second metal spring (SPR2) and a first metal plate (PLT2).

The second metal spring (SPR2) may include a plurality of metal springs that are two-dimensionally arranged on a second metal plate (PLT2). For example, the plurality of metal springs may be arranged at regular intervals along the first direction (D1) and the second direction (D2) intersecting the first direction (D1). That is, the plurality of metal springs may be arranged in a checkerboard pattern. The plurality of metal springs may be arranged closely together. For example, the distance between adjacent metal springs may be about 0 mm to about 3 mm. The second metal spring (SPR2) may be composed of, for example, a plurality of metal spring units (SPR1a, see FIGS. 4A and 4B).

The second metal plate (PLT2) may include a plurality of metal plates, and the second metal spring (SPR2) may be interposed between the plurality of metal plates. For example, the second metal spring (SPR2) may be interposed between a lower metal plate and an upper metal plate.

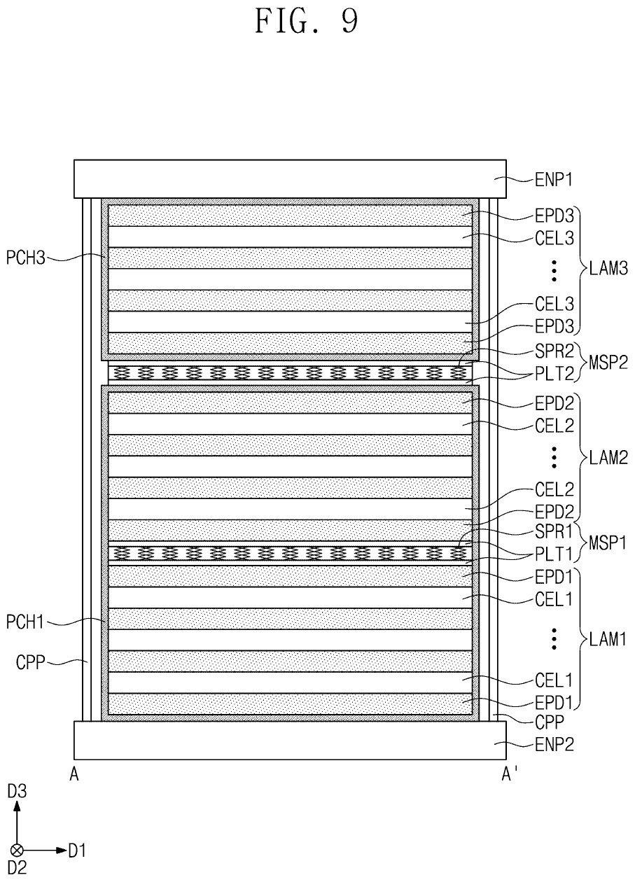

Referring to FIG. 8, the first metal spring pad (MSP1) may be interposed between the first pouch (PCH1) and the second end plate (ENP2), and the second metal spring pad (MSP2) may be interposed between the first pouch (PCH1) and the first end plate (ENP1). Alternatively, the first metal spring pad (MSP1) may be interposed between the first pouch (PCH1) and the first end plate (ENP1), and the second metal spring pad (MSP2) may be interposed between the first pouch (PCH1) and the second end plate (ENP2). That is, the first and second metal spring pads (MSP1, MSP2) may be positioned outside the first pouch (PCH1).

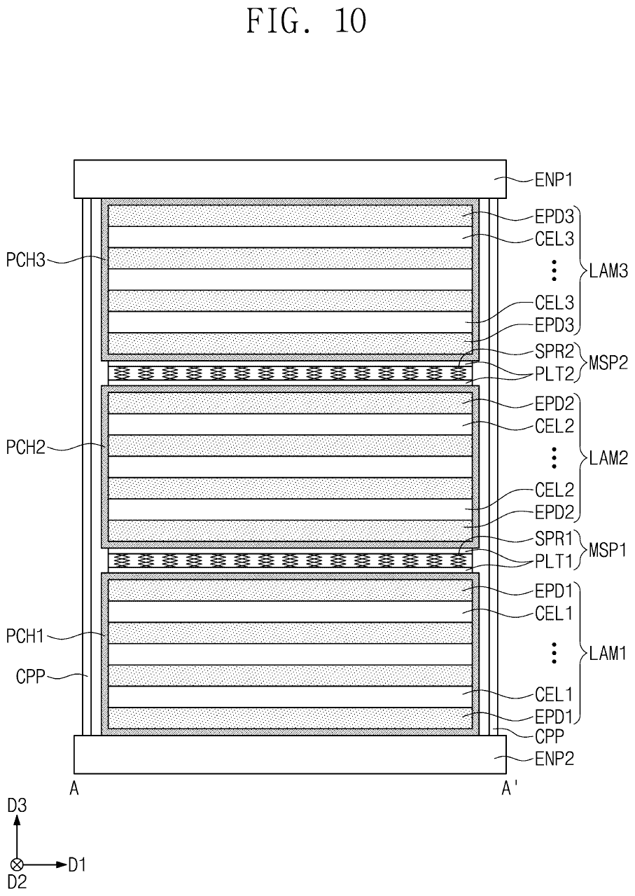

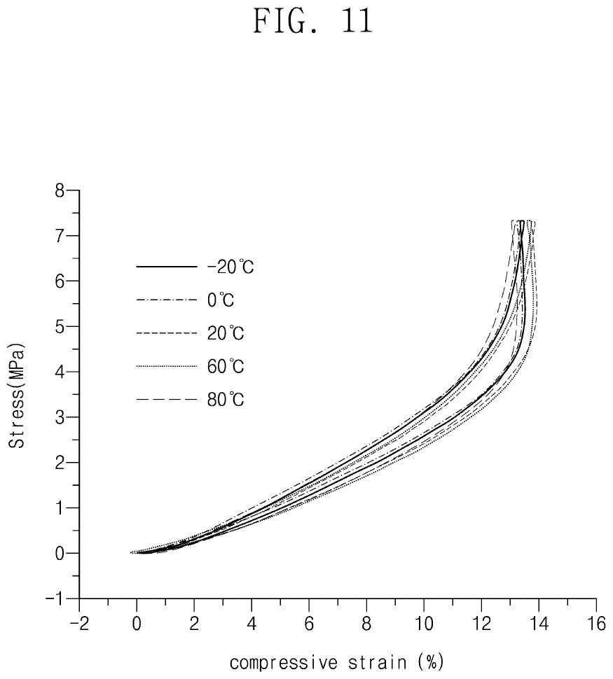

Referring to FIGS. 9 and 10, the all-solid-state battery may further include a third stack (LAM3) and a third pouch (PCH3). The third stack (LAM3) may be interposed on the second stack (LAM2). The second metal spring pad (MSP2) may be interposed between the first and second end plates (ENP1, ENP2). For example, the second metal spring pad (MSP2) may be positioned between the first pouch (PCH1) and the third pouch (PCH3), or between the second pouch (PCH2) and the third pouch (PCH3).

The third stack (LAM3) may include at least one third battery cell (CEL3) and at least one third elastic pad (EPD3). The third stack (LAM3) may include a plurality of third battery cells (CEL3) and a plurality of third elastic pads (EPD3). The third stack (LAM3) may be formed by alternately stacking the plurality of third battery cells (CEL3) and the plurality of third elastic pads (EPD3). For example, the third stack (LAM3) may be formed by stacking the third battery cell (CEL3) on the third elastic pad (EPD3), and stacking the third elastic pad (EPD3) on the third battery cell (CEL3). However, the present invention is not limited to the described embodiment.

Each of the third battery cells (CEL3) may include a positive electrode layer, a negative electrode layer facing the positive electrode layer, and a solid electrolyte layer disposed between the positive electrode layer and the negative electrode layer. However, the third battery cell (CEL3) may further include an additional functional layer such as an adhesion enhancing layer disposed between the positive electrode layer and the solid electrolyte layer or between the negative electrode layer and the solid electrolyte layer. The specific components of each of the third battery cells (CEL3) may be the same as or different from those of the first battery cells (CEL1). The specific components of each of the third battery cells (CEL3) may be the same as or different from those of the second battery cells (CEL2).

Each of the third elastic pads (EPD3) may include an insulating material. For example, the material of the third elastic pad (EPD3) may include, but is not limited thereto, an epoxy resin, an acrylic resin, a polyimide resin, a polyester resin, a polypropylene resin, a polyamide resin, a polystyrene resin, a polyvinyl chloride resin, a polycarbonate resin, a fluororesin such as PTFE, a silicone rubber, or the like. The specific components of each of the third elastic pads (EPD3) may be the same as or different from those of the first elastic pads (EPD1). The specific components of each of the third elastic pads (EPD3) may be the same as or different from those of the second elastic pads (EPD2).

The third pouch (PCH3) may enclose the third stack (LAM3). For example, the third stack (LAM3) may be injected into the third pouch (PCH3) and sealed under vacuum.

Hereinafter, the present invention will be described in more detail through an example. However, the example is intended to exemplify the present invention and the scope of the present invention is not limited to the described example.

### EXAMPLE

A metal spring pad including metal springs and metal plates was prepared. The metal springs were positioned between two metal plates and were arranged in a checkerboard pattern on one metal plate. Adjacent metal springs were arranged at intervals of less than about 2 mm. Each of the metal springs was formed by stacking a plurality of metal spring units, and each of the metal spring units had a wave spring shape. The diameter of the metal spring unit was about 7 mm. Each of the metal springs included stainless steel (SUS). The thickness of the metal spring pad was about 3 mm to about 20 mm.

### Experimental Example 1: Investigation of Usable Temperature of Pad

Using the pad of the Example, the physical properties were investigated according to the temperature change. The physical properties were examined by pressing/releasing at a speed of about 0.01 mm/s up to about 7.5 MPa at a specific temperature.

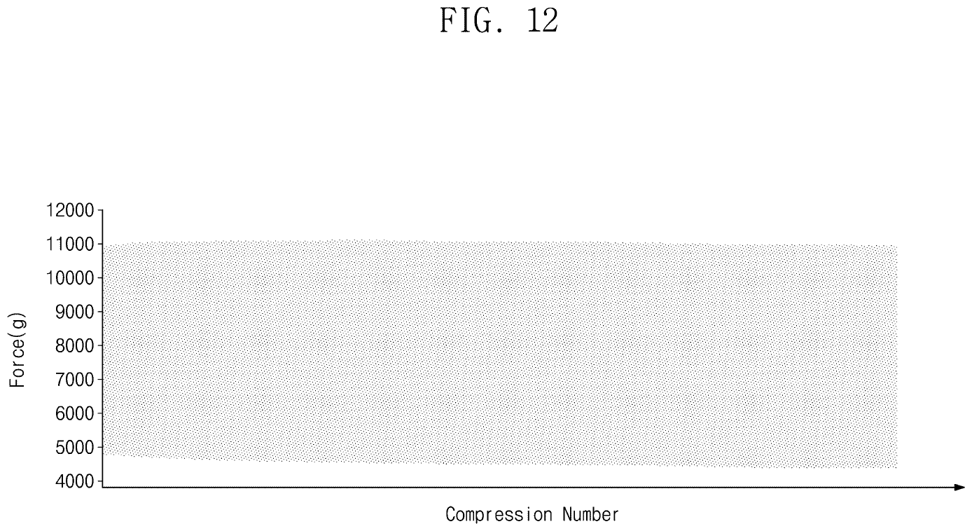

The results of the Example are shown in FIG. 11. Referring to FIG. 11, it was confirmed that the physical properties of the Example were maintained at high and low temperatures.

### Experimental Example 2: Investigation of Lifespan of Pad

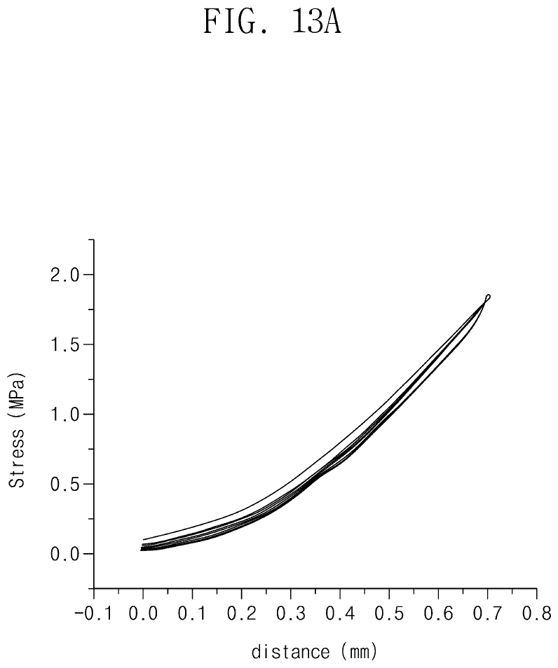

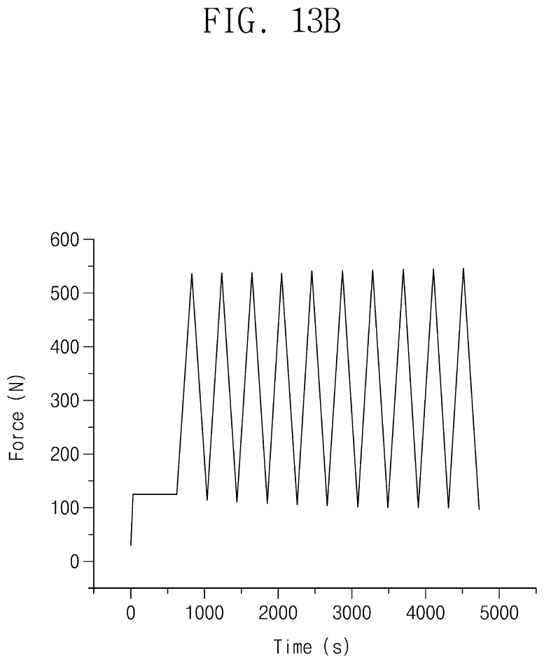

The lifespan of the pad of the Example was investigated through a compression test. The compression test was conducted by measuring the force or pressure applied from the outside when the pad of the Example was contracted. In the case of FIG. 12, first, a press was performed at a speed of about 0.01 mm/s to a specific pressure (MPa). Then, an additional press was performed at a speed of about 0.1 mm/s to y mm, and a release was performed at a speed of about 0.1 mm/s to y mm, and the process was repeated 1000 times. In the case of FIG. 13, first, a press was performed at a speed of about 0.01 mm/s to a specific pressure (MPa). Then, an additional press was performed at a speed of about 0.01 mm/s to b mm and a release was performed at a speed of about 0.01 mm/s to b mm, and the process was repeated 10 times.

FIG. 12 is the result of measuring the external force applied as the compression was repeated 1000 times. Referring to FIG. 12, the force of the Example was maintained without a significant decrease (approximately 95%).

Referring to FIG. 13A, even if the compression was repeated 10 times in the range of about 30% strain, the Example did not undergo permanent deformation. Referring to FIG. 13B, even if the compression was repeated, the Example did not show a significant change in the external force applied.

Through the above experimental results, it was confirmed that the lifespan of the Example was excellent.

As described above, while the embodiments of the present invention have been described with reference to the attached drawings, the present invention may be implemented in other specific forms without changing the technical idea or essential features thereof. Therefore, it should be understood that the embodiments described above are illustrations in all respects and not limiting.

1. An all-solid-state battery comprising:
a first stack comprising at least one first battery cell and at least one first elastic pad;
a first pouch enclosing the first stack;
a first end plate on the first stack;
a second end plate under the first stack, the first and second end plates sandwiching the first stack; and
a first metal spring pad interposed between the first and second end plates.

2. The all-solid-state battery of claim 1,
wherein a second stack is further comprised on the first stack, and
the second stack comprises at least one second battery cell and at least one second elastic pad.

3. The all-solid-state battery of claim 2, wherein the first spring pad is interposed between the first stack and the second stack.

4. The all-solid-state battery of claim 2,
wherein a second pouch enclosing the second stack is further comprised, and
the first metal spring pad is interposed between the first pouch and the second pouch.

5. The all-solid-state battery of claim 1,
wherein a second metal spring pad is further comprised on the first stack, and
the second metal spring pad is spaced apart from the first metal spring pad in a vertical direction.

6. The all-solid-state battery of claim 5, wherein the first pouch encloses the first stack, the first metal spring pad, and the second metal spring pad together.

7. The all-solid-state battery of claim 5,
wherein the first metal spring pad is interposed between the first pouch and the second end plate, and
the second metal spring pad is interposed between the first pouch and the first end plate.

8. The all-solid-state battery of claim 2, further comprising:
a third stack on the second stack;
a third pouch enclosing the third stack; and
a second metal spring pad interposed between the first and second end plates,
wherein the third stack comprises at least one third battery cell and at least one third elastic pad.

9. The all-solid-state battery of claim 1, wherein the first metal spring pad comprises a first metal spring and a first metal plate.

10. The all-solid-state battery of claim 9, wherein the first metal spring comprises a plurality of metal springs arranged two-dimensionally on the first metal plate.

11. The all-solid-state battery of claim 10, wherein the plurality of metal springs are arranged at regular intervals along a first direction and a second direction intersecting the first direction.

12. The all-solid-state battery of claim 9, wherein the first metal spring comprises at least one selected from the group consisting of a coil spring, a leaf spring, a volute spring, a ring spring, a reel spring, a disc spring, a washer spring, a wave spring, a snap spring, and a torsion bar spring.

13. The all-solid-state battery of claim 9, wherein a material of the first metal spring comprises at least one selected from the group consisting of stainless steel and hard drawn steel.

14. The all-solid-state battery of claim 1, wherein a thickness of the first metal spring pad is about 3 mm to about 30 mm.

15. The all-solid-state battery of claim 1, wherein the first metal spring pad is used at about −50 °C to about 150 °C.

16. The all-solid-state battery of claim 1, wherein a thermal conductivity of the first metal spring pad is about 0.01 W/mK to about 15 W/mK.

17. The all-solid-state battery of claim 1, wherein the first metal spring pad is non-combustible.

18. The all-solid-state battery of claim 1, wherein the battery cell comprises a positive electrode layer, a negative electrode layer and a solid electrolyte layer between the positive electrode layer and the negative electrode layer.

19. The all-solid-state battery of claim 1,
wherein the positive electrode layer comprises a positive electrode current collector and a positive electrode active material layer, and
the negative electrode layer comprises a negative electrode current collector and a negative electrode coating layer.

20. The all-solid-state battery of claim 1, wherein the elastic pad has a smaller elasticity compared to that of each of the positive electrode layer and the negative electrode layer.
